(19) United States
(12) Patent Application Publication
(10) Pub. No.: US 2003/0068427 A1
(43) Pub. Date: Apr. 10, 2003

(54) Material for making biodegradable mouldings from bran and method thereof

(76) Inventor: Jerzy Wysocki, Zambrow (PL)

Correspondence Address: BANNER & WITCOFF, LTD., 28 STATE STREET, 28th FLOOR, BOSTON, MA, 02109, US

(21) Appl. No.: 10/161,330

(22) Filed: Jun. 3, 2002

Related U.S. Application Data
(63) Continuation of application No. PCT/PL00/00084, filed on Nov. 23, 2000.

(30) Foreign Application Priority Data
Dec. 6, 1999 (PL) P.336969
Jun. 16, 2000 (PL) P.340816

(51) Int. Cl. A23K 1/00

(52) U.S. Cl. 426/615

(57) ABSTRACT

Material for making biodegradable mouldings, in particular table utensils and packaging containers according to this invention consists in 95-100% w/w of loose bran, in particular the wheat one, constituting a selected bran fraction of grain size from 0.01 to 2.80 mm containing from 7% to 45% of structurally bonded water in the form of moisture and possibly in up to 5% w/w of a mixture of impregnating substances and/or fragrance and/or aroma giving additives and/or non-fibrous fillers and/or moisture retaining agents and/or colouring additives. Method of making biodegradable mouldings, in particular table utensils and packaging containers, using grain grinding products consists in that the loose bran, in particular wheat one, of grain size 0.01 to 2.80 mm in amount of 96-100% w/w containing 7% to 45% structurally bound water in the form of moisture are dry-mixed with a mixture impregnating substances and/or fragrance and/or aroma giving additives and/or non-fibrous fillers and/or moisture retaining agents and/or colouring additives in amount of up to 5% w/w; a metered quantity of the moulding material obtained is placed on part of a multipartite, preferably bipartite, mould, the mould is being closed with simultaneous exposure of moulding material placed there for several tens of seconds to temperature within a range from 20 to 450° C. and pressure within a range of 1-10 MPa and/or compressive force of up to 100 MT/cm2 at pressure of up to 320 MPa acting of a mould closing piston.

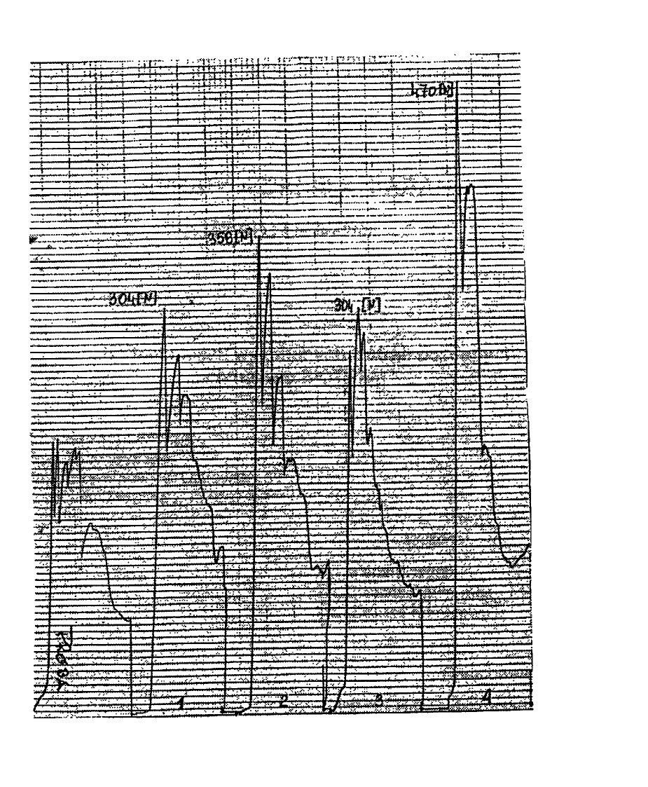

The invention refers to a material for making biodegradable mouldings. In particular table utensils and packaging containers and to a method of making such biodegradable mouldings, in particular vessels and packaging containers

The packaging industry since a longs time attempts to find alternative solutions enabling to eliminate the use of plastic materials. This problem becomes to be of particularly sharp nature in case of plastic packaging containers and disposable table utensils Disposable table utensils and packaging containers, despite of unquestionable advantages resulting from simplicity and rentability of manufacturing processes, present today a very serious problem associated with their disposal as wastes. Lack of effective recycling processes in respect to waste plastic materials and large-scale character of using disposable plastic table utensils results in avalanche-like increase in globally produced quantities of non-biodegradable and environment polluting plastic wastes.

The increasingly higher interest in production of packaging containers disposable table utensils of biodegradable materials allows to hope that they will progressively eliminate the use of plastics in this field.

Paper as commonly known material used in production of packaging, containers and disposable can be regarded as environment friendly to some extent. Paper wastes are not environmentally harmful ones but its use as material for packaging containers and table utensils does not solve the problem littering and the very nature of paper production process causes considerable pollution and contamination of natural environment.

Biodegradable packaging containers constitute a separate group of packages. Various method and materials enabling to obtain biodegradable packaging containers and disposable table utensils are already known. The product so obtained undergo natural degradation under influence of various environmental factors such as oxygen, moisture. lights and micro-organisms Packaging containers of that type are used increasingly more frequently because of environmental regulations being in force in some European countries and imposing direct constrains on production of conventional packaging containers or special taxation on their manufacturers. The cost of their production, however, still remains by about 15% higher than that of conventional packaging containers.

There are known biodegradable packaging materials containing starch and cellulose as their components. Polyethylene-based packaging materials containing 6 to 11% corn starch readily undergoes biodegradation caused by bacteria and amyiolythic enzymes. To speed up their biodegradation process special additives facilitating oxidation of polyethylene are being used This solution, however, still requires to use a biodegradation assisting system and makes necessary to implement various supplementary measures such as segregation of wastes.

The starch-based thermoplastic materials are obtained by heating up under pressure water-containing starch in presence of plastifying additives also contained therein. The article made of these materials are manufactured by extrusion process employing conventional tooling similar to that used in production of plastic extrusion-moulded articles. For example two German companies “Biopack” and “Sandoz” have introduced a starch-based packaging, material. This material is obtained by adding to starch powder various mouldability improving additives and cellulose The mixture so obtained is used to mould required products under pressure at 190° C. by extrusion. The extrusion process carried out under such process conditions does not allow to achieve exact repeatability of shape which results from the fact that moulded material after leaving the extrusion die, because of sudden change in pressure and surrounding temperature, tends to expand. The product obtained has a honeycomb-like structure formed by bundles of fused proteinous monofilaments. As result of processes taking place inside the extruder, because of combined effect of high temperature and pressure, important physiochemical changes are occurring in uncontrollable manner thus affecting repeatability of material properties. Furthermore the extrusion process is of continuous nature and its progress is not fully controllable.

To known prior-art materials belongs also that containing starch and a water-soluble polymer obtained from petroleum. Amount of starch contained in that material is from 10 to 70% One of possible application of that material is to use it for packing animal fodder Such package after being emptied can be disintegrated and added to animal fodder as fully digestible one

As an environment friendly material of biological origin the wafer dough is well known and commonly used It finds application mainly to make disposable cups for serving ice-cream. Production of such cups consists in baking them in special moulds from thin slurry-like dough made of wheat flour and water. Such wafer cups, however. readily absorb water and are becoming soft and incoherent which greatly restrains potentialities of their applications

From the Polish patent specification No 171 872 a material containing 30-85% by weight of polysaccharide-based biodegradable synthetic material and 15-70% by weight of starch or non-modified cellulose as a biodegradable additive as well as minute amounts of ancillary ingredients. This material is obtained by fusing its polysaccharide base and adding starch or cellulose thereto. This mixture has initially the form of dispersion of starch having moisture content not more than 25% or of cellulose in its polysaccharide base Then this mixture is pelletised and pellets are used to mould desired products. This process is relatively complex one and involves many stages.

A process is also known from the European patent application EP 0 51 589 according to which a packaging container is obtained in a single stage from a dough containing potato starch, small amount of cereal starch, vegetable oil, stabilisers, emulsifiers and water. The packaging container is obtained by press-forming in a suitable mould and maintaining the mould for 60-120 seconds at 65-105° C. Thereafter the mould is slowly cooled down and a moulding so obtained removed from the mould. Obtained packaging container is highly resistant to liquids and is suitable to store cold and hot articles of food.

From the Polish patent specification No. 167 213 a method of making thin-walled degradable mouldings is known. This method consists in that a mixture comprising 30 to 63% w/w water, 27-69% w/w starch base, anti-adhesive agent, thickening agent, up to 16% w/w cellulose-rich raw materials, up to 100%% w/w non-fibrous fillers, moisture retaining agent, colorant, structure hardening agent, preservative and antioxidant is baked in a mould for 25-230 seconds at 145-230° C. and subsequently conditioned so as to achieve moisture content of 6-2% w/w in a moulding obtained This method can be used to make disposable cups, plates fast-food serving/packaging boxes, food package inserts as well as paper- or cardboard-like sheets or webs The products obtained b this method have a wall thickness being on one part sufficiently thick to ensure. While observing prescribed direction for use, required resistance to breaking and cracking and on the other sufficiently thin to enable efficient baking between two halves of a conventional mould used in ordinary automatic wafer-baking, machines

In the another Polish patent specification No 174 592 an environment friendly material and a process for making disposable table utensils and packaging containers are disclosed Dry mixture of that material contains grain grinding products in amount of 50-95% w/w of dry substance, products of grinding potatoes, soybeans and other plants in amount of 0-90% w/w of dry substance and animal protein as a binder in amount of up to 30% w/w of dry substance as well as fragrance and aroma giving additives, preservatives and colorants. The ingredients as above are mixed together and with water and kneaded until a homogenous dough is obtained, then the dough is extruded and baked in conventional manner for several minutes During baking process water contained in dough evaporates resulting in destruction of inhomogenous fibrous structure of mouldings. Thus the final products show numerous cracks and identically dimensioned which makes this material and process not suitable in making thin-walled packaging containers and disposable utensils as highly strict standardisation requirements must be satisfied by such articles.

This invention aims to avoid above mentioned disadvantages of prior art biodegradable materials described above

This objective has been achieved by the material for making biodegradable mouldings, in particular table utensils and packaging container and method of making such biodegradable mouldings according to the present invention

This method of making such biodegradable mouldings consists in that from dry bran the fractions sized from 0.01 to 280 mm are selected by a known segregation process, the selected bran fractions are mixed together and with dry additives needed as required and necessary metered quantity of that mixture is placed into a suitable preheated mould; the metered portion of mixture placed into mould is subsequently exposed for 1 to 25 seconds to temperature within a range from 20 to 450° C. and pressure within a range from 5 to 450 kg;/m² in successive cycles of up to 5 seconds duration each alternately with pressure relieving during intervals between two cycles following each other Preferably the dry mixture, after preparing same and before placing it into the mould, is exposed to temperature within a range from 20 to 450° C. and pressure within a range from 5 to 450 kg/m² and thereafter, while maintaining it under pressure, the mixture is introduced into a preheated mould

The material according to present invention for making biodegradable mouldings. in particular disposable table utensils and packaging containers consists of 95-100% w/w of loose bran, in particular wheat bran and possibly of 5% w/w of a mixture of impregnating substances and/or fragrance and/or aroma giving additives and/or non-fibrous fillers and/or moisture retaining agents and/or colouring additives The loose bran used in the material according to the invention constitute a by-product of grain grinding process Usually in known flour-making processes in order to separate bran from grain the last one is moistened with water. As bran has fibrous structure it is able to absorb water in amount of up to 45% its weight in the form of structurally bonded moisture without losing its loose form. At the same time the material according to present invention should not contain less than 7% of structurally bonded moisture If its moisture content is insufficient the bran should be additionally moistened so as to keep its moisture content within 7-45%. Remaining additives constitute optional ingredients which may or may not be added depending on actual needs and intended application of final product. The bran, in particular the wheat one, used as a main constituent of material according to this invention constitute a specific selected fraction of bran sized from 0.01 to 2.80 mm. The material according to this invention does not contain any additives, such as e.g. flour, which would make necessary to bake it for a long time.

In a modification of the method according to this invention the loose bran, in particular wheat one, of grain size 0.01 to 2.80 mm in amount of 96-100% w/w containing 7% to 45% structurally bound water in the form of moisture are dry-mixed with a mixture impregnating substances and/or fragrance and/or aroma giving additives and/or non-fibrous fillers and/or moisture retaining agents and/or colouring additives in amount of up to 5% w/w. A metered quantity of the moulding material obtained is placed onto part of a multipartite, preferably bipartite, mould, the mould is being closed with simultaneous exposure of moulding material placed there for up to several tens seconds to temperature within a range from 20 to 450° C. and pressure within a range of 1-10 MPa and/or compressive force of up to 100 MT/cm² at pressure of up to 320 MPa acting of a mould closing piston If pressure of 1-10 MPa is to be used this is achieved by sealing the mould before closing it completely and thereafter the mould is closed completely to produce pressure therein Application of compressive force is achieved preferably by use of hydraulic presses, mechanical presses, hydraulic hammer or dedicated system specifically designed for that purpose The material mixture after preparing same but before placing it into a mould is, preferably exposed to temperature within a range of 20-450° C. and pressure of 1-10 MPa All parts of the mould are to be preheated and preferably temperatures of upper and lower parts of the mould are different so as to enable to control direction of flow of steam venerated. This also enable to chose which surface of a moulding in question (top or bottom one) is to be less porous one. The exposure material to temperature and pressure or compressive force, lasting up to several tens of seconds can be accomplished either in a single cycle or in several cycles, each being of several seconds long, with relieving pressure during intervals between any two successive cycles. The single-cycle mode of bringing the method according to the invention into effect Is possible if a mould in question is provided with small slits, orifices or open pores enabling to vent off steam generated during exposure to high temperature. Preferably final products are coated with a film-forming substance in any known manner. It is also desirable to pelletise or subject to briquetting the material before placing it into a mould In case when briquetting has been chosen it is desirable when weight of each briquette is equal to that of a portion of material required to make a given moulding or to a fraction of that portion obtained by dividing it by an integer, which greatly facilitates the production process. The actual figures of process variables such as temperature, pressure, compressive force, moisture content of bran as well as grain size of bran use are chose, within their respective ranges specified, in dependence on moulding size, wall thickness and shape of final products

It has been found that bran, in particular that form wheat grain, containing structural water in the form of moisture, when processed by the method according to this invention enable to obtain mouldings of their material structure quite different from that obtained using a material prepared in the form of dough from bran mixed with water and then baked in conventional manner. Sudden evaporation of structural moisture results in quite different mechanism of final product structure formation than that observed in case of similar material containing bran and not bonded water It should be stated finally that the method of this invention enables to obtain quite new natural material of mouldings obtained thereby

The method as per this invention enables achieve exceptionally high repeatability of final products as far as their dimensions and strength parameters are concerned. The final products obtained thereby have high and uniform mechanical strength, are free of cracks, show very little rate of production rejects are resistant to soaking with water, give very good thermal insulation when used to serve hot dishes. At the same time when used as packaging containers for particulate matter they exhibit exceptionally good container content ventilation properties as compared with any prior art packaging materials owing to the specific structure of final products.

As compared with prior-art conventional plastic packaging containers or those made of partially biodegradable plastic the moulding according to this invention are characterised by exceptionally high biodegradation rate not longer than 30 days On the other hand, as compared with wholly biodegradable prior-art mouldings, these made of material and using the method according to present invention have much better mechanical, utility and aesthetic properties. The method according to this invention does not give rise to generation of production wastes and allows to use a completely natural raw material, Furthermore the material and method according to this invention allow to obtain practically any disposable mouldings. The field of application for these mouldings can be expanded far beyond the typical application of end product of that type known from the prior art. The material and method according to this invention can be successfully used to make mouldings for packaging, practically irrespective of overall dimensions and purpose of packaging containers, for wide range of commodities as well as those constituting disposable utensils in broadest meaning of this word i.e. also as medical containers for example.

### EXAMPLE I

From loose bran of structurally bonded moisture content amounting to 17%, obtained from wheat grain grinding process the following granulanty fractions in amounts as follows have been selected by sifting: 0.1/0.2-33% w/w, 0.2/0.4-25% w/w, 0.4/0.8 mm −40%. The moulding material for making biodegradable moulding has been prepared by mixing 99% w/w of so selected bran with 0.3% w/w of sorbite, 0.4% of roasted sugar and 0.3% w/w of certified food colour

### EXAMPLE II

Similar moulding material as that of Example I has been prepared, with the only difference that moisture content in Wheat brain was 7% Before mixing that bran with remaining ingredients it%as additionally moistened to increase humidity up to final content of 28% without affecting bran friability

### EXAMPLE III

From loose bran of structurally bonded moisture content amounting to 17%, obtained from wheat grain grinding process the following granularity fractions in amounts as follows have been selected by sifting 0 1/0.2-35% w/w, 0 2/0 4-25% w/w, 0.4/0 8 mm-40% The moulding material for making biodegradable mouldings has been prepared by mixing 96.6% w/w of so selected bran with 0.3% w/w of glycerine, 0 4% of powdered hen egg white 0.7% w/w of cocoa powder and 2% w/w of impregnating substance

### EXAMPLE IV

From loose bran of structurally bonded moisture content amounting to 12%, obtained from wheat grain grinding process the following granularity fractions in amounts as follows have been selected by sifting. 0.1/0.2-40% w/w, 0.2/0.4-40% w/w, 0.4/0.8 mm-20%. The moulding material for making biodegradable mouldings has been prepared by additionally moistening the bran used so as to increase its humidity up to final content of 18% without affecting bran friability.

### EXAMPLE V

A metered portion of material obtained in Example I has been placed on the lower half of mould mounted on a hydraulic press. Prior to that placement the both halves of the mould were preheated up to 430° C. After placing the material it has been exposed for 15 second to that temperature and compressive force of 75 MT/cm² at pressure exerted on the mould closing piston amounting to 240 MPa. The moulding process was conducted in three compression cycles each lasting 5 seconds with pressure relieving during intervals between cycles The moulding so obtained in the form of a tray has been subsequently coated with casein

### EXAMPLE VI

The material obtained in Example I has been subjected to a pre-treatment in bulk by exposing it to temperature of 200° C. and pressure of 4 MPa during 20 seconds. From so pre-treated material a metered portion thereof has been taken and placed on lover half of a mould previously preheated up to 350° C. Upper half of the mould has been preheated up to 380° C. Material placed into the mould has been exposed for 10 seconds in a single cycle to temperatures as above and compressive force of 50 MT/cm² at pressure exerted onto the mould closing piston amounting to 60 MPa The mouldings obtained were the disposable plates of 350 mm in diameter

### EXAMPLE VII

The material prepared as in Example III has been placed on lower half of a mould with a cup-shaped mould cavity The both halves of that mould have been previously preheated up to and maintained at equal temperatures of 400° C. Before closing the mould completely its interior has been sealed by means of a collar and closed by pressing, upper halve against the lower one and producing pressure of 7 MPa inside the mould. A disposable cup obtained has been internally coated with albumin

### EXAMPLE VIII

The material obtained in Example has been briquette by extrusion using a typical extrusion moulding machine The briquettes weighing 25 g each have been obtained which constitutes ⅓ of the weight of material necessary to mould a plate of 235 mm in diameter. Further proceeding was identical as in Example VI with the only exception that on the lower mould half 3 briquettes were placed before moulding.

### EXAMPLE IX

The whole procedure was essentially identical as in Example VII but the material, before placing it into a mould, was pelletised using a typical pelletising machine

### EXAMPLE X

A metered portion of material obtained in Example I has been placed on the lower half of mould mounted on a hydraulic press. Prior to that placement the both halves of the mould were preheated up to 430° C. After placing the material into the mould it has been exposed for 20 second to that temperature and compressive force of 75 MT/cm² at pressure exerted on the mould closing piston amounting to 240 MPa. The moulding process was conducted in four compression cycles each lasting 5 seconds with pressure relieving during intervals between cycles.

### EXAMPLE XI

The round trays of 235 mm in diameter made from the material and using the method according to this invention have been tested at the Central Research and Development Institute of the Packaging Industry. This testing included water and oil absorbability tests, axial compressive strength test and sensory assessment.

The water and oil absorbability tests were conducted in accordance with Institutes proprietary methodology. The both tests were carried on in the following manner: the trays placed on blotting paper have been filled separately with 200 ml water at temperature of 20±2° C. and 80±2° C. and edible oil at temperature 20±2° C. and then time was measured between an instant of tray placement on the blotting paper and that of observed liquid leakage onto blotting paper. Before testing the trays were conditioned by keeping them for 48 hrs at temperature of 23±1° C. and relative humidity of surrounding air amounting to 50±2%, in accordance with conditions specified in the Polish standard specification PN-92P-50067 “Paper, cardboard and fibrous materials Standardised conditioning conditions”.

Determination of axial compressive strength has been performed in accordance with internal testing procedure of said R&D Institute No PBn/DOJI/03.11 ,,Determination of axial compressive strength developed on the basis of the Polish standard specification PN-75/O-79172 “Plastic unit packages Determination of axial compressive strength” The tests were performed using the strength testing machine INSTRON, model TM-M for four trays obtained as described above. During each test a load vs. deformation diagram was recorded until destruction of material tested took place.

The sensory assessment was performed in accordance with internal testing procedure of said R&D Institute No. PBn/DOJ/04.05 “Determination of odour and taste transfer in direct contact” developed on the basis of the Polish standard specification PN-87/O-79114 “Determination of odour and taste transfer in direct contact”. The sensory assessment was performed by means of triangle method using powdered sugar and flour as standard substances

The results of water and oil absorbability tests have been summarised in the Table 1 whereas these concerning the axial compressive strength test and sensory assessment in the Table 2 The figure attached shows a diagram of compressive force vs, deformation relationship obtained during the axial compressive strength test of trays mentioned above.

TABLE 1
Results of testing the trays made of wheat bran

| Seq | | | |
|---|---|---|---|
| No. | Test description | Time lapsed | Symptoms observed |
| 1. | Water absorbability test | After lapse of | Swelling of material layer in contact |
| | for water at 20° C. | 3 minutes | with water, separation of single bran |
| | | | particles from tray surface |
| | | After lapse of | Pulping of whole water contacting |
| | | 12 minutes | surface of tray tested |
| | | After lapse of | Further pulping of water contacting |
| | | 30 minutes | surface without any traces of leakage |
| | | After lapse of | Leakage traces noticeable on blotting |
| | | 70 minutes | paper underlay, water penetrates |
| | | | through the tray material |
| 2. | Oil absorbability test | During 60 | Not any changes in material structure |
| | for oil at 20° C. | minutes | were observed |
| | | After lapse of | Leaking oil traces are noticeable on |
| | | 60 minutes | the blotting paper underlay, oil |
| | | | penetrates through the tray material |

TABLE 2
Results of axial compressive strength determination test
and sensory assessment

| Seq. | | Unit of | |
|---|---|---|---|
| No. | Test description | measure | Average value |
| 1. | Determination of axial compressive | N | 359 ± 78 |
| | strength | | |

| | | |
|---|---|---|
| 2. | Sensory assessment for the standard | sensory changes in standard substance in |
| | substance - powdered sugar | question: |
| | | distinctly perceivable taste and odour of |
| | | bran |
| 3. | Sensory assessment for the standard | sensory changes in standard substance in |
| | substance - flour | question: |
| | | distinctly perceivable taste and odour of |
| | | bran |

What is claimed is:

1. A method of making a biodegradable moulding of bran, wherein a bran fraction having a size of 0.01 to 2.80 mm is moistened to a structurally bound moisture content of 15-45 % by weight to obtain a mixture, which mixture is exposed to a temperature in the range of from 20 to 450° C. and a pressure in the range of from 5 to 450 kg/m2 in a preheated mould for a period of from 1 to 25 seconds in one cycle or in successive cycles of up to 5 seconds duration with alternate pressure relieving periods.

2. A method according to claim 1, wherein the bran is wheat bran.

3. A method according to claim 1, wherein the moulding is a table utensil or packaging container.

4. A method according to claim 1, wherein the mixture, before it is placed in the mould, is exposed to a temperature in the range of from 20 to 450° C. and a pressure in the range of from 5 to 405 kg/in2 for a period of from 1 to 20 seconds and is placed in the mould while it is kept under pressure.

5. A method according to claim 1, wherein an additive chosen from the group of impregnating substances, fragrances, aroma providing additives, non-fibrous fillers, moisture retaining agents, and colouring agents is added to the mixture in an amount of up to 5 % w/w.

6. A method according to claim 1, wherein the mixture is placed on a part of a multipartite, preferably bipartite, heated mould, wherein the mixture is exposed to a compressive force of up to 100 t/cm2 at piston pressure of up to 320 MPa in each cycle.

7. A method according to claim 6, wherein a bipartite mould is used wherein the upper and lower halves are preheated to different temperature.

8. A method according to claim 1, wherein the biodegradable moulding is coated with a film-forming substance.

9. A method according to claim 6, wherein the mixture is pelletised prior to placing it in the mould.

10. A method according to claim 6, wherein the mixture is briquetted prior to placing it in the mould.

11. A method according to claim 10, wherein a briquette has a weight equal to the weight needed to prepare a single moulding or to that of an integer denominator fraction of the weight needed to prepare a single moulding.

12. A biodegradable moulding obtainable by a method according to claim 1.

13. A moulding according to claim 12 having the form of a table utensil or packaging container.
